(19) United States
(12) Patent Application Publication
(10) Pub. No.: US 2011/0029515 A1
(43) Pub. Date: Feb. 3, 2011

(54) METHOD AND SYSTEM FOR PROVIDING WEBSITE CONTENT

(76) Inventors: Martin B. Scholz, San Francisco, CA (US); Shyam Sundar Rajaram, Mountain View, CA (US); George Forman, Port Orchard, WA (US); Rajan Lukose, Oakland, CA (US); Henri J. Suermondt, Sunnyvale, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/533,763

(22) Filed: Jul. 31, 2009

(51) Int. Cl. G06F 17/30

(52) U.S. Cl. 707/732; 707/E17.109

(57) ABSTRACT

An exemplary embodiment of the present invention provides a method of receiving Website content. The method includes generating a user profile comprising a cluster type obtained from a list of cluster types, wherein the list of cluster types is generated by processing a database of search queries. The method includes providing the relevant cluster types included in the user profile to a selected Website, wherein the cluster type sent to the Website is used by the Website at least in part to determine the content provided by the Website.

### BACKGROUND

Marketing on the World Wide Web (the Web) is a significant business. Users often purchase products through a company's Website. Further, advertising revenue can be generated in the form of payments to the host or owner of a Website when users click on advertisements that appear on the Website. The amount of revenue earned through Website advertising and product sales may depend on a Website's ability to attract visitors and develop a loyal base of returning visitors. Often, the ability to attract a visitor to a particular Website depends on the organization of the Website and whether the user is able to effectively navigate the Website to locate relevant information or products.

### BRIEF DESCRIPTION OF THE DRAWINGS

Certain exemplary embodiments are described in the following detailed description and in reference to the drawings, in which:

FIG. 1 is a block diagram of a computer network in which a client computer system can access a search engine and Websites over the Internet, in accordance with exemplary embodiments of the present invention;

FIG. 2 is a process flow diagram showing a method of personalizing a Website, in accordance with exemplary embodiments of the present invention;

FIG. 3 is a process flow diagram showing a method of generating a user profile, in accordance with exemplary embodiments of the present invention;

FIG. 4 is a process flow diagram showing a method of determining a cluster type in the user profile to send to a Website, in accordance with exemplary embodiments of the present invention; and

FIG. 5 is a block diagram showing a tangible, machine-readable medium that stores code adapted to facilitate the personalization of Website content, in accordance with an exemplary embodiment of the present invention.

### DETAILED DESCRIPTION OF SPECIFIC EMBODIMENTS

Exemplary embodiments of the present invention provide techniques for delivering personalized Web page content that more closely represents the interests of a visitor to a Web page. As used herein, the term “exemplary” merely denotes an example that may be useful for clarification of the present invention. The examples are not intended to limit the scope, as other techniques may be used while remaining within the scope of the present claims. The techniques disclose herein can improve a Website experience by personalizing the appearance and content of the Website, which may lead to increased traffic and, thus, revenue for the Website.

In exemplary embodiments of the present invention, cluster information is generated and used to provide a cluster type or a vocabulary of possible user interests for a user identifier (user ID) that is used to access one or more Websites. A user ID is a unique identifier used to identify a particular system used to access a Website, for example, an IP address, a user name, and the like. The cluster information may be generated by statistically processing a database of Web activity, for example, a list of search queries performed on one or more search engines from one or more different user IDs. The resulting cluster information provides groupings of Websites and groupings of words that pertain to the Websites. The groupings, referred to herein as “clusters,” may be used to characterize the content of individual Websites in terms of the interests of users that visit those Websites. Each cluster represents a unique cluster type and may be assigned a unique cluster-type descriptor.

Cluster types corresponding to the interests of a particular user are determined by accesses of a particular Website by that user's user ID. These accesses are stored in a user profile based on the prior Web activity from the user ID, such as prior search queries performed from the user ID. Upon accessing a selected Website, a determination may be made regarding which cluster types in the user profile relate to content available from the selected Website. If matching cluster types are detected, one or more of cluster types may be sent to the Website. The Website may use the cluster types to customize the Website according to the interests indicated by accesses from the user ID.

Exemplary embodiments of the present invention enable a Website to receive relevant user interest information from a visitor while reducing the likelihood that extraneous or irrelevant user interest information of the visitor will also be received by the Website. Additionally, sending a cluster type to the Website rather than more detailed search query information may help to protect the privacy of Website visitors while still enabling the delivery of personalized Website content.

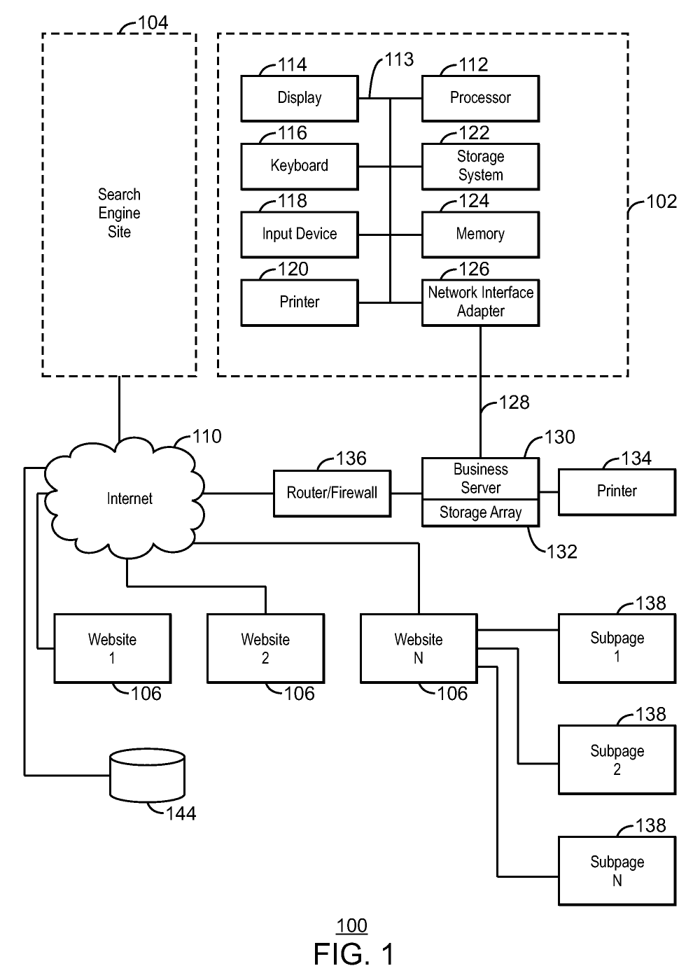

FIG. 1 is a block diagram of a computer network 100 in which a client system 102 can access a search engine 104 and Websites 106 over the Internet 110, in accordance with exemplary embodiments of the present invention. Although the Websites 106 are actually virtual constructs that are hosted by Web servers (not shown), they are described herein as individual (physical) entities, as multiple Websites 106 may be hosted by a single Web server and each Website 106 may collect or provide information about particular user IDs. Further, each Website 106 will generally have a separate identification, such as a URL, and function as an individual entity. As illustrated in FIG. 1, the client system 102 will generally have a processor 112 which may be connected through a bus 113 to a display 114, a keyboard 116, and one or more input devices 118, such as a mouse or touch screen. The client system 102 can also have an output device, such as a printer 120 connected to the bus 113.

The client system 102 can have other units operatively coupled to the processor 11 2 through the bus 113. These units can include tangible, machine-readable storage media, such as a storage system 122 for the long term storage of operating programs and data, including the programs and data used in exemplary embodiments of the present techniques. The storage system 122 may also store a database of cluster information and a user profile generated in accordance with exemplary embodiments of the present techniques. Further, the client system 102 can have one or more other types of tangible, machine-readable storage media, such as a memory 124, for example, which may comprise read-only memory (ROM) and/or random access memory (RAM). In exemplary embodiments, the client system 102 will generally include a network interface adapter 126, for connecting the client system 102 to a network, such as a local area network (LAN 128), a wide-area network (WAN), or another network configuration. The LAN 128 can include routers, switches, modems, or any other kind of interface device used for interconnection.

Through the LAN 128, the client system 102 can connect to a business server 130. The business server 130 can have a storage array 132 for storing enterprise data, buffering communications, and storing operating programs for the business server 130. The business server 130 can have associated printers 134, scanners, copiers and the like. The business server 130 can access the Internet 110 through a connected router/firewall 136, providing the client system 102 with Internet access. Those of ordinary skill in the art will appreciate that business networks can be far more complex and can include numerous business servers 130, printers 134, routers 136, and client systems 102, among other units. Moreover, the business network discussed above should not be considered limiting as any number of other configurations may be used. For example, in other exemplary embodiments, the client system 102 can be directly connected to the Internet 110 through the network interface adapter 126, or can be connected through a router or firewall 136. Any system that allows the client system 102 to access the Internet 110 should be considered to be within the scope of the present techniques.

Through the router/firewall 136, the client system 102 can access a search engine 104 connected to the Internet 110. In exemplary embodiments of the present invention, the search engine 104 can include generic search engines, such as GOOGLE™, YAHOO®, BING™, and the like. The client system 102 can also access the Websites 106 through the Internet 110. The Websites 106 can have single Web pages, or can have multiple subpages 138. The Websites 106 can also provide search functions, for example, searching subpages 138 to locate products or publications provided by the Website 106. For example, the Websites 106 may include sites such as EBAY®, AMAZON.COM™, WIKIPEDIA™, CRAIGSLIST™, FOXNEWS.COM™, and the like. Further, one or more of the Websites 106 may be configured to receive information from a visitor to the Website, for example, from a unit located at a particular user ID, regarding interests of the user, and the Website may use the information to determine the content to deliver to the user ID.

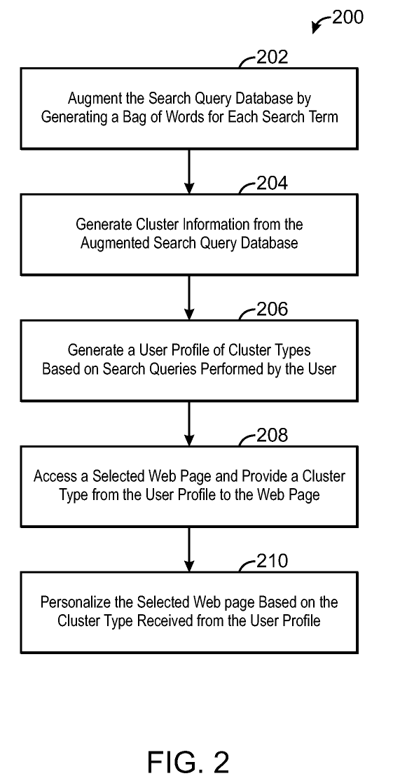

The client system 102 may also access a database 144, which is connected to the Internet 110 and includes details of searches performed from a plurality of user IDs across a plurality of Websites. The search query data may be collected by an Internet service provider (ISP) or by the Website 106. Each search query record in the database 144 may include one or more search terms and an associated Website. The associated Website may be the Website that the user ID was accessing when the search was performed, or the associated Website may be the Website that the user ID accessed after performing the search. The database 144 may also include cluster information, which may be generated, at least in part, by an automated analysis of the search query data, as described below in reference to FIG. 2. The cluster information may be used to communicate a user's interests to a selected Website, as discussed with respect to FIG. 2.

FIG. 2 is a process flow diagram showing a method of personalizing a Website, in accordance with exemplary embodiments of the present invention. Referring also to FIG. 1, the method 200 will generally be executed on a client system 102. However, in other exemplary embodiments, all or part of the method 200 may be executed on other devices, such as the search engine 104, or an individual Website 106. The method begins at block 202, wherein the search query data from the database 144 may be augmented by generating a bag-of-words representation of the search query data. The bag-of-words representation expands each search term of the search query data into a larger group of related words. For example, if a user ID is used to perform a search query using the search terms “science” and “news,” the bag of words may include the original search terms plus additional words such as “NASA,” “health,” “biology,” “climate,” and the like. Thus, each Website in the augmented search query data may be correlated with an expanded list of words applicable to the Website.

The bag of words may be generated by any suitable technique. In one exemplary embodiment, a bag of words may be generated for each search term by using the original search term to perform a new search on a canonical search engine, such as YAHOO® or GOOGLE™. A specified number of the top ranked Web pages returned by the search may be accessed, and each word from each Web page may be added to the bag of words applicable for that search term. In exemplary embodiments of the present invention, the list of words from each Web page may be processed to eliminate common or unimportant words, such as “a”, “the,” “HTTP,” Tag,” and the like. Further, frequency algorithms may be applied to select only a subset of the words if desired. Such algorithms may eliminate words that are used too few times in a site to be significant, for example, words that appear only once, twice, or a few times. In addition, techniques such as Porter stemming algorithms may be applied to eliminate common suffixes and further narrow the list.

Prior to performing the new search, the original search term may be expanded based on the Website associated with it. For example, if the original search query was performed at a Website of a book vendor, the search term used in the new search may be expanded by adding the word “book.” Similar rules can be constructed for domain specific-Websites. For example, highly targeted websites may sell a particular category of products such as garden supplies, in which case the expansion is straightforward due to the limited number of possible terms. In other cases, a search at a website that sells a wide array of products (for example, AMAZON.COM™) can be expanded based on the subsequent link that was clicked on from the search results page. Further, some websites allow categorical searches and the knowledge of the category information leads to a natural way of expanding the search. Additionally, if the search query data includes the Website that was clicked on at the time of the original search, each word from that Web page may also be added to the bag of words.

At block 204, cluster information is generated from the augmented search query data. The cluster information may be generated by automated analysis of the augmented search query data, for example, a statistical analysis such as clustering, co-clustering, information-theoretic co-clustering, and the like. In one exemplary embodiment of the present invention, the automated analysis includes loading the augmented search query data into a word/Website matrix and segmenting the words and Websites into clusters. The resulting cluster information may include groupings of words and Websites, referred herein as “clusters,” that may be used to classify subject matter available on the Internet. As used herein, the term “cluster type” refers to a unique cluster that represents a particular user interest or type of Web content. Each cluster type may be associated with a group of words that characterize the cluster type as well as one or more Websites that contain subject matter relevant to the cluster type. Each cluster may also be assigned a unique cluster-type descriptor, as will be explained further below. An exemplary clustering technique may be better understood with reference to Table 1.

Table 1 is a graphical representation of an exemplary word/Website matrix that may be used to generate the clustering information. It should be recognized that this is a simplification as many applications will generally be more complex, as discussed below. As shown in Table 1, words from the search query data may be distributed along rows and Website addresses from the search query data may be distributed along columns. For each word-Website pair in the search query data, the matrix entry at the intersection of the word and Website may be set to 1. All other matrix entries may be empty or set to zero.

After filling the matrix, the words and Websites may be grouped according to the distribution of matrix entries. The words may be grouped together based on the similarity of each word's distribution of column entries. The Websites may be grouped together based on the similarity of each Website's distribution of row entries. For example, referring to Table 1, it can be seen that the rows corresponding to the words “car,” “auto,” and “automobile” have identical distributions of column entries. Thus, the words “car,” “auto,” and “automobile” may be grouped into the same cluster. Additionally, the columns corresponding to the Websites “CARS.COM™,” “AUTOS.COM™” and “EDMONDS.COM™” have very similar distributions of row entries. Thus, the Websites “CARS.COM™,” “AUTOS.COM™” and “EDMONDS.COM™” may also be grouped into the same cluster.

TABLE 1
Example of a word/Website matrix.

| | Baseball.com | Appliance.com | Cars.com | Espn.com | Autos.com | Sports.com | Refrigertaors.com | Edmonds.com | Sears.com |
|---|---|---|---|---|---|---|---|---|---|
| Ball | 1 | | | 1 | | 1 | | | |
| Hybrid | | | 1 | | 1 | | | 1 | |
| Refrigerator | | 1 | | | | | 1 | | 1 |
| Sport | 1 | | | 1 | | 1 | | | |
| Dodge | | | 1 | | 1 | | | 1 | |
| Dryer | | 1 | | | | | | | 1 |
| Vehicle | | | 1 | | 1 | | | 1 | |
| Baseball | 1 | | | 1 | | 1 | | | 1 |
| Ford | | | 1 | 1 | 1 | | | 1 | |
| Washing | | 1 | | | | | | | 1 |
| Machine | | 1 | 1 | | 1 | | 1 | | 1 |
| Basket | | | | 1 | | 1 | | | |
| Washer | | 1 | | | | | | | 1 |
| Truck | | | 1 | | 1 | | | 1 | |
| Dish | | 1 | | | | | | | 1 |
| Goal | | | | 1 | | 1 | | | |
| Car | | | 1 | | 1 | | | 1 | |
| Auto | | | 1 | | 1 | | | 1 | |
| Automobile | | | 1 | | 1 | | | 1 | |
| Score | 1 | | | 1 | | 1 | | | |
| Runs | 1 | | 1 | 1 | 1 | 1 | | 1 | |

Table 2 represents an example of cluster information that may be obtained after the automated analysis of the exemplary word-Website matrix of Table 1. Each cluster may be assigned a unique cluster-type descriptor, for example, a cluster number. Furthermore, after the clusters have been generated via the automated analysis, the cluster data may be viewed and a textual cluster-type descriptor may be assigned to each cluster based on the apparent subject matter encompassed by each cluster. For example, the third and fourth columns of Table 2 relate to cluster 2, which has been assigned the textual cluster-type descriptor “automobiles.” The exemplary cluster includes the Websites “CARS.COM™,” “AUTOS.COM™” and “EDMONDS.COM™” and the words “car,” “auto,” and “automobile,” among others.

TABLE 2
Examples of clusters

| Cluster 1 | | Cluster 2 | | Cluster 3 | |
|---|---|---|---|---|---|
| “Sports” | | “Automobiles” | | “Home Appliances” | |
| Words | Websites | Words | Websites | Words | Websites |
| Ball | BASEBALL.COM™ | Hybrid | CARS.COM™ | Refrigerator | APPLIANCE.COM™ |
| Sport | SPORTS.COM™ | Dodge | AUTOS.COM™ | Dryer | REFRIGERATOR.COM™ |
| Baseball | ESPN.COM™ | Ford | EDMONDS.COM™ | Washer | SEARS.COM™ |
| Basket | | Truck | | Washing | |
| Goal | | Car | | machine | |
| Score | | Vehicle | | dish | |
| runs | | auto | | | |
| | | automobile | | | |

It can be appreciated from the foregoing example, that the similarity between the words and the Websites can be ascertained without knowing the meanings of the words or the content of the Websites. In other words, the process of generating the clusters does not involve human lexical interpretation.

As previously noted, the graphical representation of the word/Website matrix of Table 1 is provided merely as an aid to explaining the invention. In actual practice, the word/Website matrix will generally be more complex, for example, including several thousands of words and Website addresses stored in a machine-readable medium for electronic processing.

Furthermore, while clusters for words and websites are aligned in the present example, this is unlikely to be the case in many situations. For example, if there are 100 word clusters and just 20 website clusters, each website (or website cluster) could then be represented in terms of the 100 word clusters. This may be performed by determining the counts of how many words from each of these clusters belong to that website. Further, some websites (like AMAZON™) might cover books, appliances, music, etc., while others (APPLIANCE.COM) might just cover appliances. The clustering algorithm would segment searches into clusters like “books”, “appliances”, “music”, “cars”, and the like. AMAZON™ would be connected to the first 3 clusters (but not to “cars”), but APPLIANCES.COM™ would just be connected to the appliances cluster. Accordingly, in exemplary embodiments, searches done on APPLIANCES.COM™ could be transferred to AMAZON.COM™, but only a subset of AMAZON.COM™ searches would be transferred to APPLIANCES.COM™.

The cluster information may provide a vocabulary that may be used to characterize the interests of various users and the subject matter offered by various Websites. Thus, the clustering information may be used to match user interests with relevant Website content. Accordingly, referring also to FIG. 1, the clustering information may be accessed by both the client system 102 and Websites 106. In exemplary embodiments of the present invention, the cluster information may be generated by a third party and provided to the client system 102 and the Websites 106 via the Internet. In exemplary embodiments, the clustering information may be stored on a server of the Website 106 and the storage system 122 of the client system 102. In other exemplary embodiments, the clustering information may be stored on the database 144 and accessed by the client system 102 and the Website servers 106 through the Internet 110. Furthermore, the clustering information may be updated periodically, such as weekly, monthly, or yearly, among others.

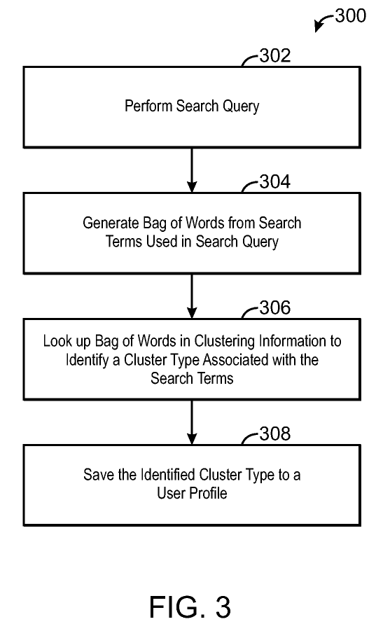

At block 206, cluster types may be stored in a user profile based on the prior Web activity from the user ID, for example, based on prior search queries from the user ID. In exemplary embodiments, search terms entered by the user in prior searches may be compared with the clustering information to determine which cluster types correspond with the search terms. Descriptors for these cluster types may be stored to the user profile. An exemplary method of generating a user profile is described further in relation to FIG. 3.

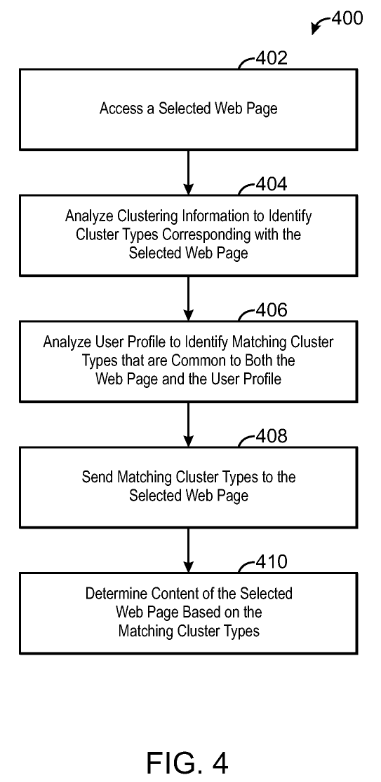

At block 208, a user ID is used to access a selected Website and the client system 102 associated with the user ID provides one or more cluster types to the Website 106. Upon accessing the Website, the client system 102 may search for matches between Website content and the user's interests as indicated by the user profile. Both the Website content and the user profile may be described in terms of cluster types. The client system 102 may search the user profile for matching cluster types that are common to both the user profile and the selected Website. One or more of the matching cluster types may then be sent to the Website server 106, enabling the Website server to personalize the Website according to a user's interests. An exemplary method of locating a cluster type in the user profile and sending the cluster type to a Website is described further in relation to FIG. 4.

At block 210, the content provided by the selected Website to the user ID of the client system 102 may be determined based on the cluster types received by the Website from the client system 102. In this way, the selected Website, including the initial Web page and subsequent subpages, may be personalized according to interests indicated by a particular user ID.

FIG. 3 is a process flow diagram showing a method of generating a user profile, in accordance with exemplary embodiments of the present invention. The method 300 is generally performed by the client system 102 (FIG. 1). However, in other exemplary embodiments, the method 300 may be performed by other devices, such as the search engine 104 or an individual Website 106. The method 300 begins at block 302, wherein a search query is performed from a user ID. The search query may be performed using any type of search engine, for example, a canonical search engine such as GOOGLE™, YAHOO®, BING™, and the like. Additionally, the search may be performed on a search engine specific to an individual Website 106, for example, a news Website such a FOXNEWS.COM™ or a vendor Website such as AMAZON.COM™.

At block 304, the search terms used in the search query may be used to generate a bag of words. The bag of words may be generated according to the method described in reference to block 202 of FIG. 2. As discussed above, the resulting bag of words represents an expanded list of words related to the search terms used in the search query.

At block 306, the bag of words may be compared with the clustering information to determine one or more cluster types that correspond with the search performed by from the user ID at block 302. The cluster types applicable to the search may be determined by correlating the words in the bag of words with the words included in the cluster information. The cluster types that have the most words in common with the bag of words may be added to the user profile. For example, each word in the bag of words may be looked for in the clustering information and a match between a word in the bag of words and a word in a specific cluster type may result in a “hit” for that cluster type. The total number of hits for each cluster type may be tallied to determine the one or more cluster types that correspond more closely with the words in the bag of words.

At block 308, cluster types may be saved to the user profile. Saving a cluster type to the user profile may include saving the cluster-type descriptor corresponding with the cluster type to the user profile. In exemplary embodiments of the present invention, the cluster type with the highest number of hits may be saved to the user profile. In other exemplary embodiments, two or more cluster types may be added to the user profile depending on the distribution of hits between the cluster types. For example, the cluster types may be ranked according to the total number of hits for each cluster type, and two or more of the top ranked cluster types may be entered into the user profile. In exemplary embodiments of the present invention, the method 300 is performed by the user's computer, for example the client system 102. In other exemplary embodiments, the method 300 may be performed by the Website at which the user performed the search query referenced in block 302. Accordingly, the Website may save the cluster type to the user profile by storing the cluster type in a cookie on the user's computer. In other exemplary embodiments, the method 300 may be performed at a server hosted by the ISP or a third party based on the search query referenced in block 302.

In an exemplary embodiment of the present invention, each cluster type entered into the user profile may be associated with a time factor that may be used to determine the age of each cluster type entry in the user profile. The time factor may include a time stamp indicating the date and/or time that the cluster type was added to the user profile. Alternatively, the time factor may include a time-decaying weighted vector that may be periodically adjusted to indicate an age of the cluster type entry. In some exemplary embodiments, the time-decaying weighted vector may be periodically adjusted to decay exponentially over time. The time factor may be used to attach greater relative importance to more recent searches. In this way, more user interests indicated by more recent Website accesses may take priority over user interests indicated by older Website accesses in personalizing a Website for a particular user ID.

Additionally, each cluster type entered into the user profile may be ranked to indicate a magnitude of the user's interest in the content related to the cluster type. In one exemplary embodiment, each cluster type entry may be associated with a frequency indicator that indicates a number of times that the user ID was used to perform a search corresponding with the cluster type. Accordingly, if a user ID is used to perform a search corresponding with a cluster type that has been previously added to the user profile, the frequency indicator for that cluster type entry may be incremented. Methods of personalizing the content of a Webpage are further described in relation to FIG. 4.

FIG. 4 is a process flow diagram showing a method of determining a cluster type in the user profile to send to a Website, in accordance with exemplary embodiments of the present invention. The method 400 is generally performed by the client system 102 (FIG. 1). However, in other exemplary embodiments, all or part of the method 400 may be performed by other devices, such as the search engine 104, or an individual Website 106. The method 400 begins at block 402, wherein a user ID is used to access a Website. For example, the user ID may access the Website by a user clicking on a hyperlink or by a user typing the address of the Website in the address bar of a Web browser.

At block 404, the cluster information may be analyzed to identify cluster types corresponding with the selected Website. For example, the list of clusters in the cluster information may be searched to identify the one or more clusters that include the address of the selected Website. As a further illustration, if the user ID accesses AMAZON.COM™, analysis of the cluster information may identify cluster types pertaining to books, movies, video games, electronics, and any other product available on the AMAZON.COM™ Website.

At block 406, the user profile may be analyzed to identify matching cluster types that are common to both the selected Webpage and the user profile. The matching cluster types may indicate a match between the user interests and the available content that may be provided by the selected Website.

At block 408, the one or more matching cluster types may then be sent from the client system 102 to the Website 106. In some embodiments, sending a cluster type to a Website 106 may include sending the cluster-type descriptor corresponding with the cluster type to the Website 106. As discussed above in relation to FIG. 1, the cluster-type descriptor may include a cluster ID code or a textual descriptor corresponding to the subject matter of the cluster type. In some embodiments, sending a cluster type to the Website 106 may include sending one or more of the words included in the cluster type to the Website 106.

In some instances, several matching cluster types may be identified for a particular Website and user profile. Therefore, the client system 102 may send a subset of the matching cluster types to the Website server. Accordingly, the matching cluster types may be ranked and the subset of matching cluster types may include one or more of the top ranked matching cluster types. In some exemplary embodiments, the ranking of the matching cluster types may be based, in part, on the magnitude of the user interest as indicated, for example, by the frequency indicator. In other exemplary embodiments, ranking of the matching cluster types may be based, in part, on the age of the user interest as indicated, for example, by the time stamp or the time-decaying weighted vector associated with the cluster type in the user profile. In this way, more relevant matching cluster types may be sent to the Website server.

For example, if a user ID was used to perform a large number of searches related to fly fishing shortly in time (for example, within a day, a week, or a month) before accessing AMAZON.COM™, a matching cluster type related to fly-fishing may be given a high rank compared to other matching cluster types. Thus, the AMAZON.COM™ Website may be more likely to display books related to fly fishing. Conversely, if a user ID was used to perform a small number of searches related to astronomy several months prior to accessing AMAZON.COM™, a matching cluster type related to astronomy may be given a low rank compared to other matching cluster types. Thus, the AMAZON.COM™ Website may be less likely to display books related to astronomy. In some exemplary embodiments of the present invention, the rank associated with each cluster type may also be sent to the selected Website.

At block 410, the selected Website may determine the content of the initial Web page based on the one or more matching cluster types received from the client system 102. For example, if the selected Website is AMAZON.COM™ and the Website receives a cluster type related to an interest in astronomy, the AMAZON.COM™ initial Web page may be personalized to display books related to astronomy. Furthermore, referring to FIG. 1, sub pages 138 that the user ID accesses may also be personalized, such as by being automatically selected as the entry page for a user ID accessing the Website. For example, a user that often searches for books may see the top page of the books section of AMAZON™ as their initial entry into the AMAZON.COM™ Website.

The process used by the Website to determine subject matter related to the cluster type may depend on the way in which the cluster type was sent to the Website. For example, if a textual cluster-type descriptor is sent to the Website, the Website may perform a keyword search using the textual descriptor. Similarly, if one or more words from the cluster are sent to the Website, the Website may perform a keyword search using the one or more words from the cluster. Subject matter located via the keyword search may then be incorporated into the initial Web page and subsequent subpages to which the user ID may access. In this example, the Website may or may not have access to the cluster information. However, if a cluster ID number is sent to the Website, the Website may correlate the cluster ID number with relevant subject matter known to correspond with the cluster ID number. In this example, the Website may have access to a list of subjects that correlate with each cluster ID number. Additionally, in this example, the Website may have access to the cluster information. Thus, the Website may use the cluster ID number to search the cluster information for the actual cluster that corresponds with the cluster ID number. The Website may then obtain the words that are included in the cluster and use those words to perform a keyword search for relevant subject matter.

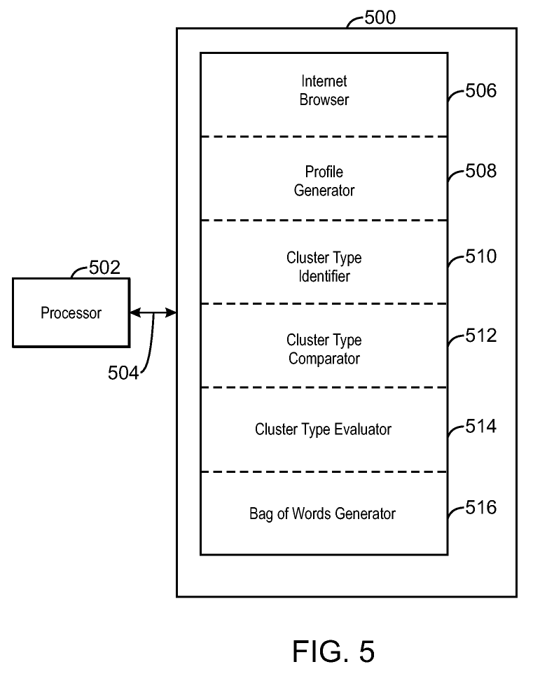

FIG. 5 is a block diagram showing a tangible, machine-readable medium that stores code adapted to facilitate the personalization of Website content, in accordance with an exemplary embodiment of the present invention. The tangible, machine-readable medium is generally referred to by the reference number 500. The tangible, machine-readable medium 500 can comprise RAM, a hard disk drive, an array of hard disk drives, an optical drive, an array of optical drives, a non-volatile memory, a USB drive, a DVD, a CD or the like. In one exemplary embodiment of the present invention, the tangible, machine-readable medium 500 can be accessed by a processor 502 over a computer bus 504.

The various software components discussed herein can be stored on the tangible, machine-readable medium 500 as indicated in FIG. 5. For example, a first block 506 on the tangible, machine-readable medium 500 may store an Internet browser adapted to access a selected Web page. A second block 508 can include a profile generator configured to add a cluster type to a list of cluster types included in the user profile based on search queries performed by a user. A third block 510 can include a cluster type identifier for identifying a list of cluster types corresponding with the selected Web page. A fourth block 512 can include a cluster type comparator for analyzing a user profile to identify one or more matching cluster types common to both the Web page and the user profile and send the matching cluster types from the user profile to a selected Web page. A fifth block 514 can include a cluster type evaluator, which can be used to rank the matching cluster types according to a magnitude of user interest and/or a length of time that has elapsed since the matching cluster type was added to the user profile. A sixth block 516 may include a bag-of-words generator that receives a search term used in a search query performed by the user, performs a new search query using the search term to identify a Website, and adds word from the Website to a bag of words.

Although shown as contiguous blocks, the software components can be stored in any order or configuration. For example, if the tangible, machine-readable medium 500 is a hard drive, the software components can be stored in non-contiguous, or even overlapping, sectors.

What is claimed is:

1. A method of receiving Website content, comprising:
generating a user profile comprising a cluster type obtained from a list of cluster types, wherein the list of cluster types is generated by processing a database of search queries; and
providing the cluster type included in the user profile to a selected Website, wherein the cluster type provided to the Website is used by the Website, at least in part to determine content provided by the Website.

2. The method of claim 1, further comprising determining a matching cluster type, the matching cluster type being the cluster type that is common to both the user profile and the selected Website.

3. The method of claim 1, wherein each of the cluster types in the list of cluster types corresponds to a list of Websites and a corresponding list of words that relate to content available on the Website.

4. The method of claim 1, wherein generating the user profile comprises obtaining a search term during a search query and identifying the cluster type associated with the search term.

5. The method of claim 4, wherein identifying the cluster type associated with the search term comprises:
generating a bag of words based on the search term; and
identifying the cluster type associated with the bag of words.

6. The method of claim 5, wherein generating the bag of words based on the search term comprises:
performing an additional search query using the search term;
obtaining words from a Website identified via the search query; and
adding the words to the bag of words.

7. The method of claim 1, wherein generating the user profile comprises:
adding the cluster type to the user profile; and
adding a time factor associated with the cluster type to the user profile.

8. A computer system, comprising:
a processor that is adapted to execute machine-readable instructions;
a storage device that is adapted to store data, the data comprising a user profile that includes a cluster type obtained from a list of cluster types, wherein the list of cluster types is generated by processing a database of search queries performed from a plurality of user IDs across a plurality of Websites; and
a memory device that stores instructions that are executable by the processor, the instructions comprising:
an Internet browser configured to access a selected Web site over a network interface and receive Web content corresponding to the cluster type sent from the computer system to the selected Web site;
a profile generator that adds the cluster type to the user profile based on search queries performed from the user ID; and
a cluster type comparator that sends the cluster type from the user profile to a selected Web page.

9. The computer system of claim 8, wherein the cluster type comparator is configured to identify a matching cluster type, the matching cluster type being the cluster type that is common to both the user profile and the selected Web site.

10. The computer system of claim 8, wherein the instructions comprise a bag-of-words generator that:
receives a search term used in a search query performed from the user ID;
performs a new search query using the search term to identify a second Website; and
adds word from the second Website to a bag of words.

11. The computer system of claim 10, wherein the profile generator is configured to add the cluster type to the user profile that corresponds with the bag of words.

12. The computer system of claim 8, wherein the profile generator is configured to add time stamps to the user profile, the time stamps corresponding to a date, time, or both, that the cluster type was added to the user profile.

13. The computer system of claim 8, wherein the profile generator is configured to add frequency indicators to the user profile, the frequency indicators corresponding to a number of times that each cluster type was added to the user profile.

14. The computer system of claim 8, wherein the list of cluster types is determined via at least one of clustering, co-clustering, or information-theoretic co-clustering.

15. The computer system of claim 9, wherein the instructions comprise a cluster-type evaluator adapted to rank the matching cluster types according to a magnitude of user interest, a length of time that has elapsed since the matching cluster type was added to the user profile, or both.

16. A tangible, computer-readable medium, comprising code configured to direct a processor to:
access a selected Web page;
analyze a list of clusters to identify a first list of cluster types corresponding with the selected Web page;
analyze a user profile comprising a second list of cluster types to identify a matching cluster type that is common to both the first list and the second list; and
send the matching cluster type to the selected Web page.

17. The tangible, computer-readable medium of claim 16, comprising code configured to direct the processor to rank the matching cluster type according to a magnitude of user interest.

18. The tangible, computer-readable medium of claim 16, comprising code configured to direct the processor to rank the matching cluster type according to a length of time that has elapsed since the matching cluster type was most recently updated in the user profile.

19. The tangible, computer-readable medium of claim 16, comprising code configured to direct the processor to add the cluster type to the second list of cluster types included in the user profile based on search queries performed from a user ID.

20. The tangible, computer-readable medium of claim 16, comprising code configured to direct the processor to:
receive a search term used in a search query performed from the user ID;
perform a new search query using the search term to identify a Website; and
add words from the Website to a bag of words.
